(19) United States
(12) Patent Application Publication
(10) Pub. No.: US 2024/0234837 A1
(43) Pub. Date: Jul. 11, 2024

(54) IMPROVED RECHARGEABLE LITHIUM BATTERY ASSEMBLY

(71) Applicant: SHENZHEN ORIENTAL WILLING NEW ENERGY CO., LTD, Shenzhen (CN)

(72) Inventor: KUNLI WANG, Shenzhen (CN)

(21) Appl. No.: 18/177,354

(22) Filed: Mar. 2, 2023

(30) Foreign Application Priority Data
Jan. 5, 2023 (CN) 202310015390.9

(51) Int. Cl. H01M 10/42; H01M 10/052; H01M 10/44; H01M 50/107; H01M 50/202; H01M 50/284; H01M 50/296; H01M 50/55; H01M 50/559; H01R 13/66; H01R 13/717

(52) U.S. Cl. CPC H01M 10/425; H01M 10/052; H01M 10/44; H01M 50/107; H01M 50/202; H01M 50/284; H01M 50/296; H01M 50/55; H01M 50/559; H01R 13/665; H01R 13/7175; H02J 7/0042

(57) ABSTRACT

The present disclosure provides an improved rechargeable lithium battery assembly, has a cylindrical battery body which may be charged and discharged independently, a cylindrical charging plug is detachably connected to the battery body for charging external electronic device. while disassembled, the battery body may be used as a power source to supply external electronic products. while assembled, the two parts into one whole, the charging plug and the battery body may be used to charge external electronic devices, allowing the charging device to be used for a variety of purposes.

### CROSS-REFERENCE TO RELATED APPLICATIONS

The present disclosure claims priority to Chinese Patent Application No. 202310015390.9 filed on Jan. 5, 2023, the content of which is incorporated herein by reference in its entirety.

### TECHNICAL FIELD

The present disclosure relates to a lithium battery assembly, and more particularly to an improved rechargeable lithium battery assembly which can be conveniently assembled and disassembled.

### BACKGROUND

As a source of energy, portable lithium battery has a stable voltage and current, and its performance is stable and reliable, and is widely used in all aspects of modern social life. Especially cylindrical batteries, such as common lithium battery models 18650 or 21700, which is more common than ordinary size 5 or 7 batteries, with a more suitable for lithium battery capacity and charge-discharge law of battery type. The battery type has gradually formed a commercial ecology of lithium batteries.

A common rechargeable battery includes an external charger that matches the rechargeable battery to charge it, and a charging circuit integrated with the rechargeable battery (called a rechargeable battery assembly) is directly connected to the power supply. It's charging. Compared with an external charging device, a rechargeable battery with a built-in charging circuit that can be directly connected to a power source is more portable and less expensive. For example, Chinese patent No. 200580040272.3 discloses a rechargeable battery assembly which can be folded and discharged to power a load through the protrusions on the cap. It increases the complexity of the structure of the rechargeable battery assembly and causes the rechargeable battery assembly to work unstably due to the inaccurate positioning of the internal component connections.

Therefore, it is necessary to provide a lithium battery assembly for solving the issues.

### SUMMARY

In view of this, the present disclosure is designed to provide an improved rechargeable lithium battery assembly to improve connection reliability.

The portable and improved rechargeable lithium battery assembly has a battery body which can be charged and discharged independently, a charging plug which is detachably connected to the battery body for charging external electronic devices.

In another aspect, the battery body has a first end surface, and the first end surface is provided with a positive electrode and a negative electrode. The charging plug has an elastic assembly oriented toward the first end surface that can be electrically connected with the positive electrode and negative electrode. A detachable clamping assembly is provided between the charging plug and the first end surface.

In another aspect, the positive electrode is convex in the center of the first end surface, and the negative electrode is along the edge region of the first end surface. The elastic assembly has a spring which is abut against the positive electrode and a binding post which is abut against the negative electrode.

In another aspect, the spring is provided on the center of the charging plug, and the number of the binding post is two, which are symmetrically provided on both sides of the spring.

In another aspect, the clamping assembly further has an inverted hook which is positioned on the charging plug and extends toward the first end surface, and the inverted hook is matched with a clamping hole arranged on the first end surface. Alternatively, the clamping assembly also includes a clamping hole located at the charging plug and oriented toward the first end surface, and clamping hole accommodates an inverted hook raised on the first end surface.

In another aspect, the charging plug comprises a shell matched with the battery body, the shell is in shaped of a cylinder, and a supported plate connected with the inner wall of the shell. The inverted hook or the clamping hole is arranged on the supported plate, and the supported plate is provided with a first through hole and a second through hole for receiving the spring and the binding post, respectively.

In another aspect, the charging plug has a first circuit board provided on the supported plate. The spring and the binding post are arranged on the first circuit board, and a charging interface is connected on the first circuit board.

In another aspect, the charging plug further has a top cover arranged at one end of the charging plug far away from the battery body. The top cover is provided with a through groove which may be exposed by the protruding of the charging interface. The first circuit board is provided with a power indicating LED (Light Emitting Diode). The top cover is provided with an indicating window for emitting light of the power indicating LED.

In another aspect, the battery body has a main shell, a battery core, a second circuit board arranged in one end of the main shell, and an end plate covered on the second circuit board. The positive electrode is positioned on the second circuit board and extends from the end plate and is detachably connected to a positive electrode of the battery core. A negative electrode of the battery core is a conductive ring surrounding the second circuit board. The negative electrode on the second circuit board is positioned beside the positive electrode and is electrically connected with the negative electrode of the battery core.

In another aspect, the positive electrode of the battery core is provided with a conductive screw, the second circuit board is provided with a conductive nut electrically connected to the positive electrode, the conductive screw being threadedly connected to the conductive nut. Alternatively, the positive electrode of the battery core is provided with a conductive nut, the second circuit board is provided with a conductive screw electrically connected to the positive electrode, the conductive screw being threadedly connected to the conductive nut.

The improved rechargeable lithium battery assembly provided by the present disclosure has two parts that may be disassembled and connected. while disassembled, the battery body may be used as a power source to supply external electronic products, such as the battery body may be applied to a torch alone. while assembled, the two parts into one, the charging plug and the battery body may be used to charge external electronic devices, so that the charging device achieves multiple uses.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiment.

FIG. 1 is an isometric view of an improved rechargeable lithium battery assembly in accordance with an exemplary embodiment of the present disclosure.

FIG. 2 is an isometric view of the improved rechargeable lithium battery assembly in FIG. 1, with the charging plug separated from the battery body.

FIG. 3 is an isometric view of the improved rechargeable lithium battery assembly in FIG. 1, with the housing of charging plug and the battery body being removed away.

FIG. 4 is an isometric view of a part of the charging plug in FIG. 2, viewed from another aspect.

FIG. 5 is an isometric exploded view of the improved rechargeable lithium battery assembly in accordance with an exemplary embodiment of the present disclosure.

### DETAILED DESCRIPTION

Embodiments of the present disclosure will be described in detail in conjunction with the drawings. It should be noted that the figures are illustrative rather than limiting. The figures are not drawn to scale, do not illustrate every aspect of the described embodiments, and do not limit the scope of the present disclosure.

It should be noted that when a component is considered to be “connected” to another component, it can be directly connected to another component or a central component can be present between two components at the same time. When a component is considered to be “provided” another component, it may be arranged directly on another component or possibly with a centered component.

Unless otherwise defined, all technical and scientific terms used herein have the same meaning, which is used in the description of the present disclosure to describe specific embodiments and is not intended to limit the disclosure. The term “or/and” used here includes any and all combinations of one or more of the associated listed items.

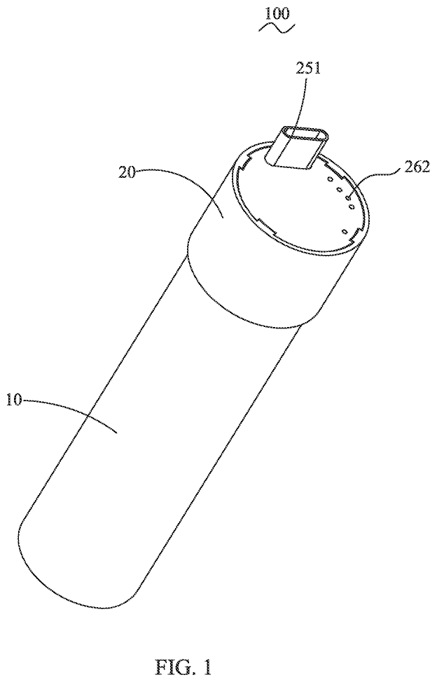

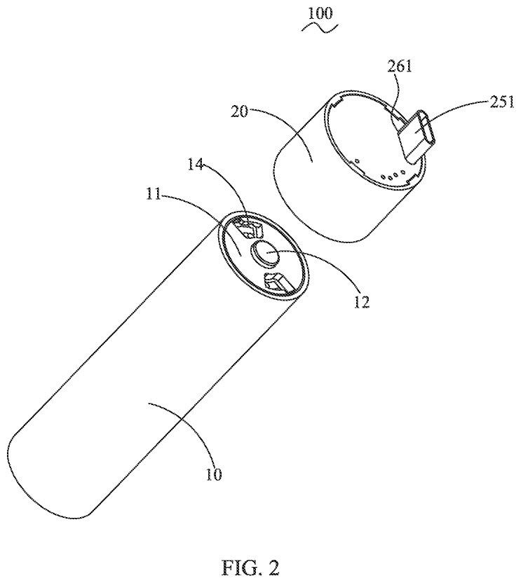

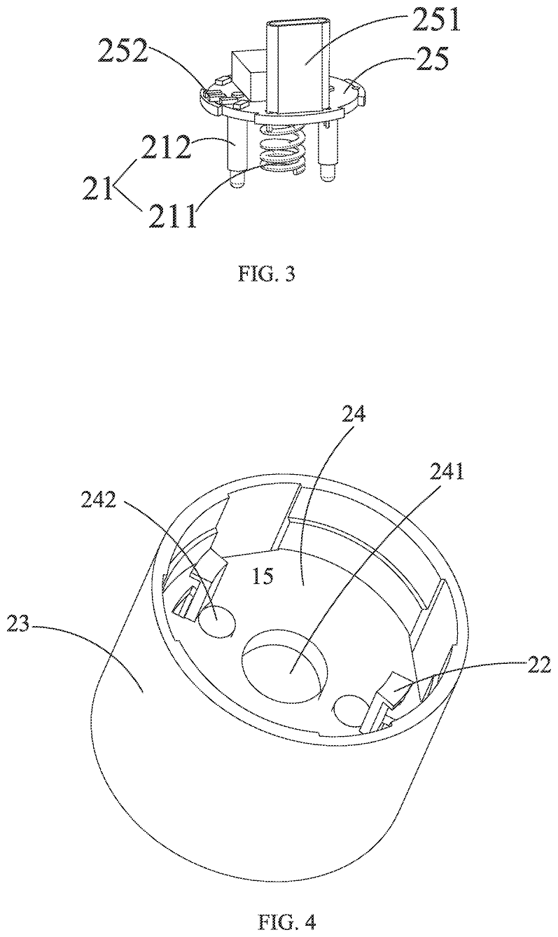

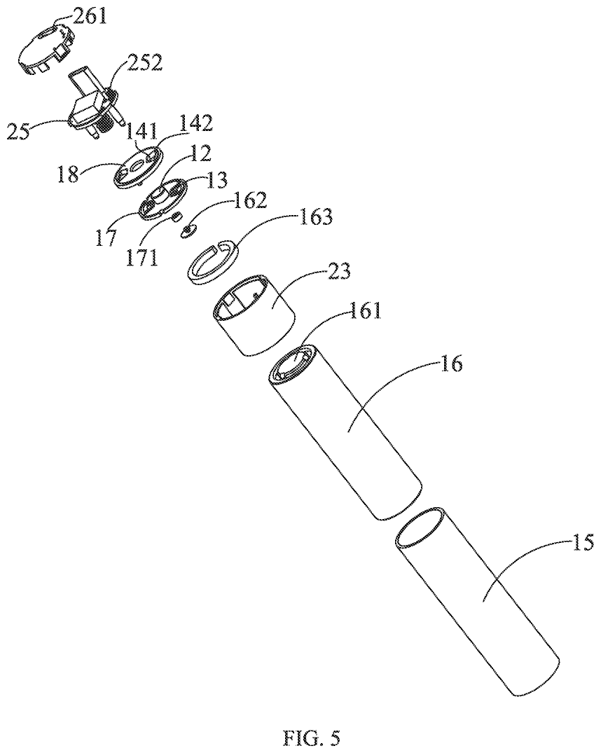

Referring to FIGS. 1 to 5, an improved rechargeable lithium battery assembly according to an embodiment of the present disclosure is shown. The lithium battery assembly 100 comprises a battery body 10 and a charging plug 20, which are detachably or connectable to each other. While disassembled, the battery body 10 may be used as a power supply for external electronic products. While the two parts are assembled into one whole, the external electronic device can be charged by using the charging plug 20 and the battery body 10. The rechargeable lithium battery assembly 100 realizes multi-purpose, brings convenience to daily use. The charging plug 20 is detachable and connected with the battery body 10, so the disassembly and assembly are more convenient.

The lithium battery body 10 comprises a cylindrical battery core 16 such as models 18650 and 21700. This type of battery core 16 has a cylindrical shape. A first end surface 11 is provided at one end of the battery body 10. The first end surface 11 is provided with a positive electrode 12 and a negative electrode 13. The charging plug 20 has an elastic assembly 21 which is provided towards the first end surface 11 for electrical connected to the positive electrode 12 and the negative electrode 13. A detachable clamping assembly is provided between the charging plug 20 and the first end surface 11 of the battery body 10. In this embodiment, the elastic assembly 21 provides the electrical connection between the battery body 10 part and the charging plug 20, and the detachable clamping assembly provides the physical connection between the two, making the connection very firm.

In the embodiment, The positive electrode 12 of the battery body 10 is projected at the center of the first end surface 11. The negative electrode 13 is arranged on the edge of the first end surface 11 and surrounds the positive electrode 12. The elastic assembly 21 includes a spring 211 which is bonded to the positive electrode 12 and a binding post 212 which is bonded to the negative electrode 13. The spring 211 and the binding post 212 are electrically connected with the positive electrode 12 and the negative electrode 13 by means of an elastic contact.

Furthermore, to make the electrical connection more stable, the spring 211 electrically connected to the positive electrode 12 is located on the center of the charging plug 20, and the binding post 212 electrically connected to the negative electrode 13 is two, symmetrically arranged on both sides of the spring 211.

In this embodiment, the detachable clamping assembly includes an inverted hook 22 positioned on the charging plug 20 and facing the first end surface 11, and a clamping hole 14 positioned on the first end face 11 for receiving the inverted hook 22. The charging plug 20 is connected with the battery body 10 when the inverted hook 22 22 is inserted into the clamping hole 14. The spring 211, the binding post 212 and the elastic reaction of the positive electrode 12 and the negative electrode 13 enable the inverted hook 22 to be more firmly fastened in the clamping hole 14, preventing the charging plug 20 from falling off the battery body 10. A method for connecting the hole 14 and the inverted hook 22 is that the charging plug 20 is first rotated relative to the battery body 10 so that the inverted hook 22 slides into the hole 14, the second step presses down to make the inverted hook 22 smoothly buckled in the hole 14. In order to achieve the above steps, the clamping hole 14 is a non-regular hole which has a main hole 141, and a secondary hole 142 extending from the main hole 141 towards the edge of an end plate 18. A size of the auxiliary hole 142 is smaller than that of the main hole 141. The inverted hook 22 extends through the auxiliary hole 142. Once the charging plug 20 is rotated relative to the end plate of the battery body 10, the end barb of the inverted hook 22 is confined in the main hole 141 such that the battery body 10 and charging plug 20 are firmly attached. In this embodiment, the inverted hook 22 is arranged inside the charging plug 20 to prevent the inverted hook 22 from being exposed to external forces and being damaged. Alternatively, the positions between the clamping hole 14 and the inverted hook 22 may be interchanged. For example, the clamping hole is arranged on the charging plug 20, and the inverted hook 22 is arranged on the first end surface 11 of the battery body 10.

In this embodiment, the charging plug 20 includes a cylindrical housing 23, a supported plate 24 which is perpendicular to the wall of the cylindrical housing 23. The inverted hook 22 is arranged on the supported plate 24, and the supported plate 24 is provided with a first through hole 241 and a second through hole 242 which are respectively adapted to be penetrated by the spring 211 and the binding post 212. The position of the inverted hook 22 is interchanged with that of the clamping hole 14 which is provided on the supported plate 24. In this embodiment, the charging plug 20 further includes a first circuit board 25 disposed therein, and a top cover 26 extending from the housing wall of cylindrical housing 23. The first circuit board 25 is located on the supported plate 24. The first circuit board 25 is provided with a charging interface 251, such as a USB port. The spring 211 and the binding post 212 are arranged on the first circuit board 25. The top cover 26 is arranged at one end of the cylindrical housing 23 far away from the battery body 10. A through groove 261 is arranged on the top cover 26. The charging interface 251 on the first circuit board 25 extends outwards from the through groove 261. The spring 211 and the binding post 212 pierce the first through hole 241 and the second through hole 242 to extend inward. The first circuit board 25 is provided with a power indicating LED 252, and the top cover 26 is provided with an indicating window 262 for emitting light of the power indicating LED 252. Visual indicator window, can see the number of power indicator lights. From the indicating window 262, user may visually see the number of power indicating LED 252.

In the embodiment, the battery body 10 has a main shell 15, a battery core 16, a second circuit board 17 arranged in one end of the main shell 15, and the end plate 18 covered on the second circuit board 17. The positive electrode 12 is positioned on the second circuit board 17 and extends from the end plate 18 and is detachably connected to a positive electrode 161 of the battery core 16. A negative electrode 163 of the battery core 16 is a conductive ring surrounding the second circuit board 17. The negative electrode 13 on the second circuit board 17 is positioned beside the positive electrode 12 and is electrically connected with the negative electrode 163 of the battery core 16. In the present disclosure, the end surface 11 is one surface of the end plate 18 and the other surface is directly or indirectly connected to the first circuit board 25.

Furthermore, the positive electrode 161 of the battery core 16 is provided with a conductive screw 162, the second circuit board 17 is provided with a conductive nut 171 electrically connected to the positive electrode 161, the conductive screw 162 being threadedly connected to the conductive nut 171. Alternatively, the positive electrode of the battery core is provided with a conductive nut, the second circuit board is provided with a conductive screw electrically connected to the positive electrode, the conductive screw being threadedly connected to the conductive nut.

In general, the rechargeable lithium battery assembly provided in this embodiment, with the structure described above, may be used as a battery alone or as a charging device to charge external electronic products. This device is easy to charge and flexible to use, enabling fast charging and enhancing the user experience.

While the present disclosure has been described with reference to a specific embodiment, the description of the disclosure is illustrative and is not to be construed as limiting the disclosure. Various of modifications to the present disclosure can be made to the exemplary embodiment by those skilled in the art without departing from the true spirit and scope of the disclosure as defined by the appended claims.

What is claimed is:

1. An improved rechargeable lithium battery assembly comprising:
a cylindrical battery body which may be charged and discharged independently, and wherein
a cylindrical charging plug is detachably connected to the battery body for charging external electronic device.

2. The improved rechargeable lithium battery assembly as described in claim 1, wherein the battery body has a first end surface, a positive electrode and a negative electrode provided on the first end surface, and the charging plug has an elastic assembly oriented toward the first end surface that may be electrically connected with the positive electrode and negative electrode, a detachable clamping assembly is provided between the charging plug and the first end surface of the battery body.

3. The improved rechargeable lithium battery assembly as described in claim 2, wherein the positive electrode is convex on the center of the first end surface, the negative electrode is provided on the edge region of the first end surface, the elastic assembly has a spring abutting against the positive electrode and a binding post abutting against the negative electrode.

4. The improved rechargeable lithium battery assembly as described in claim 3, wherein the spring is provided on the center of the charging plug, and the number of the binding post is at least two, which are symmetrically provided on both sides of the spring.

5. The improved rechargeable lithium battery assembly as described in claim 4, wherein the clamping assembly further has an inverted hook positioned on the charging plug and extending toward the first end surface, and the inverted hook is rotatably matched with a clamping hole arranged on the first end surface.

6. The improved rechargeable lithium battery assembly as described in claim 4, wherein the clamping assembly includes a clamping hole located at the charging plug and oriented toward the first end surface, and the clamping hole accommodates an inverted hook raised on the first end surface.

7. The improved rechargeable lithium battery assembly as described in claim 5, wherein the charging plug has a shell in shaped of a cylinder, a supported plate arranged in the shell, the inverted hook is arranged on the supported plate, a first through hole and a second through hole is arranged on the supported plate for receiving the spring and the binding post, respectively.

8. The improved rechargeable lithium battery assembly as described in claim 6, wherein the charging plug has a shell in shaped of a cylinder, a supported plate arranged in the shell, the clamping hole is arranged on the supported plate, a first through hole and a second through hole is arranged on the supported plate for receiving the spring and the binding post, respectively.

9. The improved rechargeable lithium battery assembly as described in claim 7, wherein the charging plug has a first circuit board supported on the supported plate, the spring and the binding post are arranged on the first circuit board, and a charging interface is provided on the first circuit board.

10. The improved rechargeable lithium battery assembly as described in claim 9, wherein the charging interface extends in a direction far from the battery body and is protrusively arranged on the charging plug.

11. The improved rechargeable lithium battery assembly as described in claim 10, wherein the charging plug has a top cover with a through slot which may be pierced by the charging interface and extends outwards, and a power indicating LED is provided on the first circuit board.

12. The improved rechargeable lithium battery assembly as described in claim 11, wherein an indicating window is provided on the top cover for emitting light of the power indicating LED.

13. The improved rechargeable lithium battery assembly as described in claim 11, wherein the battery body has a main shell, a battery core with a positive electrode and a negative electrode, a second circuit board arranged in the main shell, and an end plate covered on the second circuit board, the positive electrode of the battery body is positioned on the second circuit board and is detachably connected to the positive electrode of the battery core.

14. The improved rechargeable lithium battery assembly as described in claim 12, wherein the negative electrode of the battery core is a conductive ring which is surrounding the positive electrode of the battery core.

15. The improved rechargeable lithium battery assembly as described in claim 13, wherein a conductive screw is provided on the positive electrode of the battery core, a conductive nut is provided on the second circuit board for threadedly connecting to the conductive nut.
